(19) United States
(12) Patent Application Publication
(10) Pub. No.: US 2014/0343982 A1
(43) Pub. Date: Nov. 20, 2014

(54) METHODS AND SYSTEMS RELATED TO WORKFLOW MENTORING

(71) Applicant: LANDMARK GRAPHICS CORPORATION, Houston, TX (US)

(72) Inventors: Rachel A. SCULLY, Peppermint Grove (AU); Cynthia T. RAYBOURN, Edmond, OK (US)

(73) Assignee: LANDMARK GRAPHICS CORPORATION, Houston, TX (US)

(21) Appl. No.: 14/251,327

(22) Filed: Apr. 11, 2014

Related U.S. Application Data
(60) Provisional application No. 61/822,995, filed on May 14, 2013.

(51) Int. Cl. G06Q 10/06

(52) U.S. Cl. CPC G06Q 10/0631
USPC 705/7.12

(57) ABSTRACT

Workflow mentoring. At least some of the illustrative embodiments are methods including: creating, by a first computer system, a workflow mentoring plan for a group of users by receiving, from a second computer system, a first plurality of workflow steps, wherein at least one of the workflow steps is selected from predetermined workflow steps; receiving, from a third computer system, a second plurality of workflow steps, wherein at least one of the workflow steps is selected from the predetermined workflow steps; determining, from the first and second pluralities and the predetermined workflow steps, a value indicative of relevance weighting of each of the first and second pluralities of workflow steps, wherein the determination is made based on frequency of repetition of workflow steps; and allocating a percentage of the workflow mentoring plan to each individual step within the pluralities of steps based on the value indicative of relevance weighting.

### CROSS REFERENCE TO RELATED APPLICATIONS

This application claims the benefit of U.S. Provisional Patent Application No. 61/822,995 filed May 14, 2013, titled “Methods and Systems Related to Workflow Nuggets,” which provisional application is incorporated by reference herein as if reproduced in full below.

### BACKGROUND

Traditional mentoring and training workshops for software programs may not provide specific enough information to adequately train a user for his or her job; however, individual training sessions may prove too burdensome for trainers and/or too costly for a company. Thus, any developments which provide better training options would be beneficial.

### BRIEF DESCRIPTION OF THE DRAWINGS

For a detailed description of exemplary embodiments, reference will now be made to the accompanying drawings in which:

FIG. 1 shows a workflow mentoring session in accordance with at least some embodiments;

FIG. 2 shows a screenshot in accordance with at least some embodiments;

FIG. 3 shows a screenshot in accordance with at least some embodiments;

FIG. 4 shows a screenshot in accordance with at least some embodiments;

FIG. 5 shows a screenshot in accordance with at least some embodiments;

FIG. 6 shows a screenshot in accordance with least some embodiments;

FIG. 7 shows a flow diagram depicting an overall method in accordance with at least some embodiments; and

FIG. 8 shows, in block diagram form, a computer system in accordance with at least some embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection Thus, if a first device couples to a second device, that connection may be through a direct connection or through an indirect connection via other devices and connections.

“Workflow” shall mean a virtual representation of a business activity.

“Workflow step” shall mean an individual step representative of an action during a business activity.

“Predetermined workflow steps” shall mean a set of steps related to a workflow, wherein each step has been previously determined to be relevant to software users on the workflow. The steps may be previously determined by way of human knowledge or artificial intelligence.

“Relevance weighting” shall mean a mathematical process by which components in a set are adjusted to reflect the proportional relevance of each component within the set.

“Predetermined data” shall mean data determined prior to a current mentoring session to be relevant to software users.

“Personal Data” shall mean data specific to a user on a specific workflow topic.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. The specification first turns to a discussion of workflows in general.

Open, modular software, such as the DECISIONSPACE® brand software created by and distributed by Landmark Graphics Corporation helps users make and execute right-time productive decisions, such as decision making in well planning. In some embodiments, drag-and-drop applications enable users to create user-specific workflows which can be automated across production displays. The workflow data can be visualized from multiple sources in a common environment, and users may see the effect of a production decision in multiple areas.

Because such software enables a multitude of different technologies and methods, traditional mentoring and training workshop methods may not provide specific enough instruction to the software users. Thus, small group mentoring sessions may be instituted in which customized workflows are created based on the individual users' needs, combined with the mentor's knowledge and leadership. The specification begins with a discussion of the overall method.

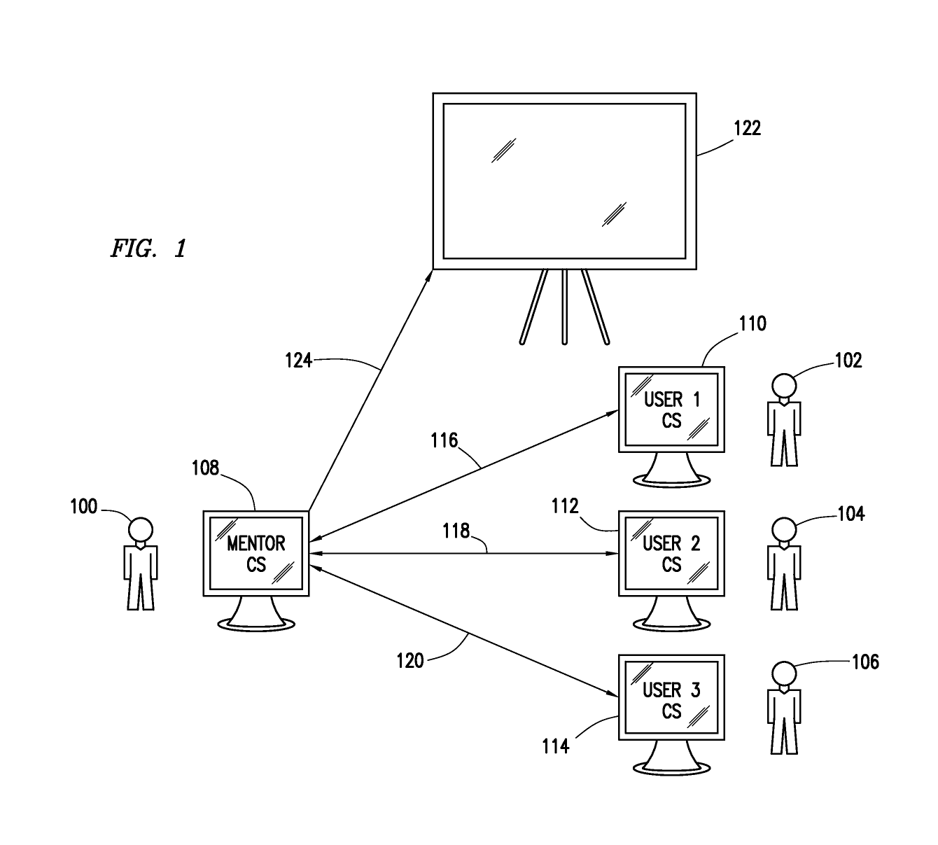

FIG. 1 shows a workflow mentoring session (hereinafter “session”) in accordance with at least some embodiments. In particular, the session begins by bringing together a group of users who wish to receive training on a specific topic or a specific workflow executing on a software application. Each mentoring session is meant to be accomplished in a short period of time, such as two to six hours, during which users can receive training for each user's specific needs on a specific workflow topic.

In one embodiment, a mentor 100 interacts with three example users 102, 104 and 106 by leading them in an interactive session. In particular, the session is a short (e.g. lasting two to four hours) interactive workshop which enables instruction on a workflow software application (e.g., DECISIONSPACE® provided by Landmark Graphics Corporation of Houston, Tex). In some cases, a session which focuses on a more complex workflow may extend the length of the workshop to five or six hours, but the session will nonetheless be conducted in a single day in many cases.

Each session focuses on a single workflow topic. For example, the discussed herein is focused on a Horizon Interpretation workflow. Another session may focus on another workflow topic, such as velocity modeling, well log correlation, log calculations, volumetrics, well planning, horizontal well correlation, or structural interpretation. The workflows on which users can be mentored using the methods and systems described herein are not limited to the workflows listed, and any contemplated workflow may be used for the sessions.

Although each session is for a single workflow, a previous or subsequent session regarding the same topic (e.g., another session with a different group on Horizon Interpretation), may yield different results, due to the fact that each session is tailored to the specific group of users. Using this method, the users do not waste time learning information and steps for which they are already well-acquainted or for which they are well-learned, and instead the methods enable users to receive the majority of instruction during the session on the steps for which there is a need for more detailed instruction.

Although the session may be for any topic, for purposes of discussion, and in the example embodiment shown in FIG. 1, a group of users meets with a mentor 100 for a few hours to create a customized workflow on the example topic of Horizon Interpretation. Furthermore, and again in order to not complicate the discussion, only three example users 102, 104 and 106 will be discussed; however, the number of users is not limited to three, and the session may be comprised of any number of users as long as there is at least one user and one mentor.

The methods described herein can be performed in a variety of ways such as entirely by way of software executing on a plurality of computer systems or by a combination of computer systems and pen-and-paper user interactions. The specification first turns to a discussion of determining a first list of workflow steps.

Phase 1—Determining the List of Predetermined Steps

In one embodiment, the mentor 100 interacts with computer system 108 by way of an input device (e.g., keyboard, mouse, stylus). In addition, each user 102, 104, and 106 interacts with computer systems 110, 112, and 114, respectively. The computer systems 108, 110, 112, and 114 may take any suitable form, such as a desktop computer, a laptop computer, or a handheld portable computer system (e.g., a smart phone, a tablet computer). Various programs and software packages may execute on each computer system which enable the various embodiments. In some cases, each program and/or software executes on its own computer system, the interaction occurring by way of a network connections 116, 118, and 120 (e.g., a local area network (LAN), wide area network (WAN), across the Internet). In other cases, two or more programs and/or software packages may execute on the same computer system. In yet another embodiment, each computer system may be communicatively coupled to a remote server. Further still, some or all of the programs and/or software packages may execute in a “cloud” computing environment, where the “cloud” computing environment may be a group of remote server systems which share work load dynamically.

Information displayed on a display device of computer system 108 may be projected onto a display system 122 in order to enable the group (i.e., the mentor and the users) to see what is on the mentor's display device. In one embodiment, the display system 122 may be a monitor communicatively coupled to computer system 108 by way of a wired or wireless communication protocol (shown by communication arrow 124). In another embodiment, computer system 108 may be connected to a projector system which projects the display of computer system 108 onto a wall or other flat surface such as a whiteboard, chalkboard, or easel pad.

Before the session begins, the mentor 100 provides to each of the users 102, 104, and 106 a handout specific to the current workflow topic; a predetermined workflow software file (e.g. a file written in extensible markup language (xml) format); and a flowchart of an example workflow (e.g., a flowchart provided in Microsoft Visio format). Users may follow along with the provided items as the session progresses, and users may also take notes on or personalize each item throughout the session.

The first interactive phase of the session thus begins with an exercise to establish the needs and expectations of the users 102, 104, and 106. In one embodiment, the mentor queries the users on what the users believe to be the individual workflow steps each user wants to concentrate on within the specific workflow (e.g., the workflow steps on horizon interpretation for which each user believes he or she would benefit from mentoring). Querying the users may be by way of personal interactions (i.e., verbal and/or written communications) or by way of communications between the computer systems.

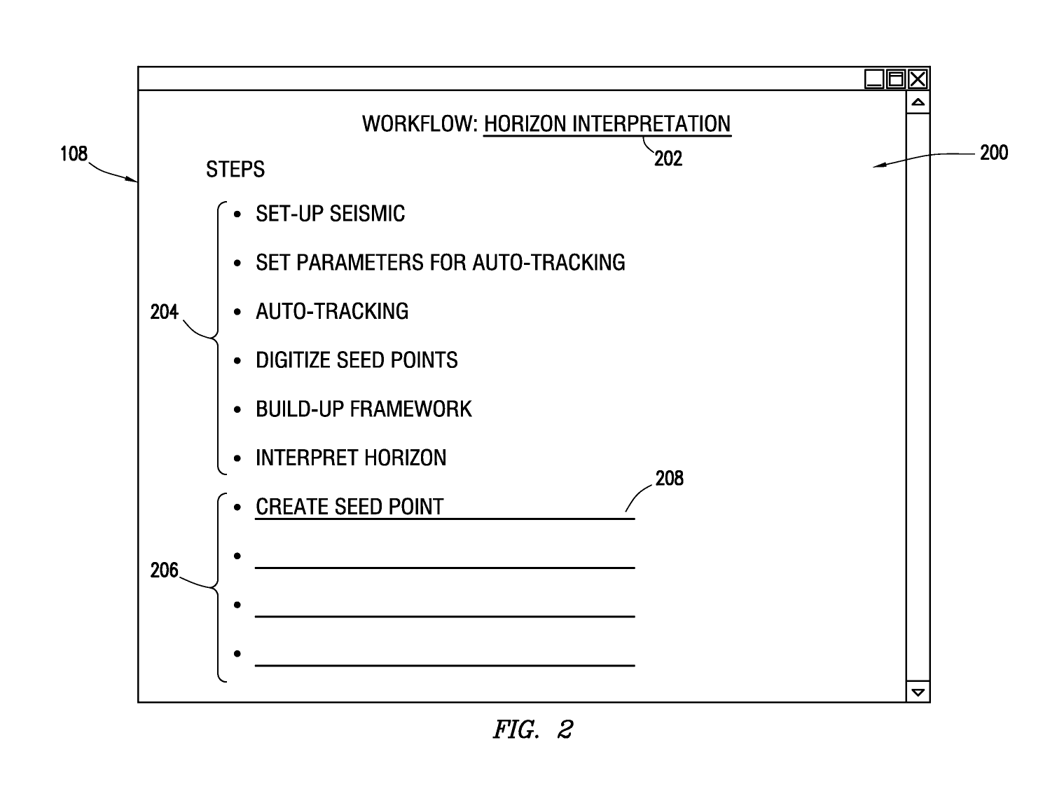

FIG. 2 shows an example screenshot of the display device on computer system 102. In particular, FIG. 2 shows a screenshot of what the mentor 100 may first see on his or her display during the first phase of the session. In the example screenshot 200 shown in FIG. 2, a title bar 202 shows the session is for Horizon Interpretation. In addition, a plurality of predetermined workflow steps 204 (hereinafter “predetermined steps”) for the Horizon Interpretation workflow 202 is displayed. In this example, the six predetermined steps 204 include: “set-up seismic”; “set parameters for auto-tracking”; “auto-tracking”; “digitize seed points”; “build-up framework”; and “interpret horizon”.

The predetermined steps 204 may be workflow steps anticipated as being steps where the users may desire additional training. In addition to the predetermined steps, however, the mentor 100 may anticipate that the users may benefit from instruction on additional workflow steps not included in the list of predetermined steps 204. Thus, in this example screenshot 200 of FIG. 2, the software comprises a fill-in section 206 where the mentor can add additional steps to be presented to the users.

Additional steps may be added in a variety of different ways. In one embodiment, the mentor 100 may enter each additional step into the software using his or her own wording by way of an input device (e.g., a keyboard, a mouse, a stylus). In another embodiment, the mentor 100 may select a step from a second group of predetermined steps presented within an on-screen “step bank” (not specifically shown). In this embodiment, the mentor 100 may use an input device coupled to the computer system 108 in order to “drag-and-drop” each of the chosen steps into the section 206.

In the example embodiment of FIG. 2, the mentor has determined that an additional step 208: “create seed point,” should be included in the plurality of predetermined steps 204 which will be provided to users in the next phase of the session. Once the mentor has made a determination as to whether any additional steps will be added, the list of predetermined steps 204 are provided to the users for the next phase of the session.

Phase 2—Users Respond with Preferred Steps (Computer Method)

Each of the users in the group will be presented with a list of predetermined steps (i.e., combination of steps 204 and 206 from FIG. 2). The predetermined steps may be presented to the users in a variety of ways. In one embodiment, the predetermined steps may be sent from computer system 108 to each of the computer systems 110, 112, and 114 by way of a wired or wireless communication. In another embodiment, the predetermined steps may be displayed on the display device 122 (from FIG. 1) which is visible to the entire group.

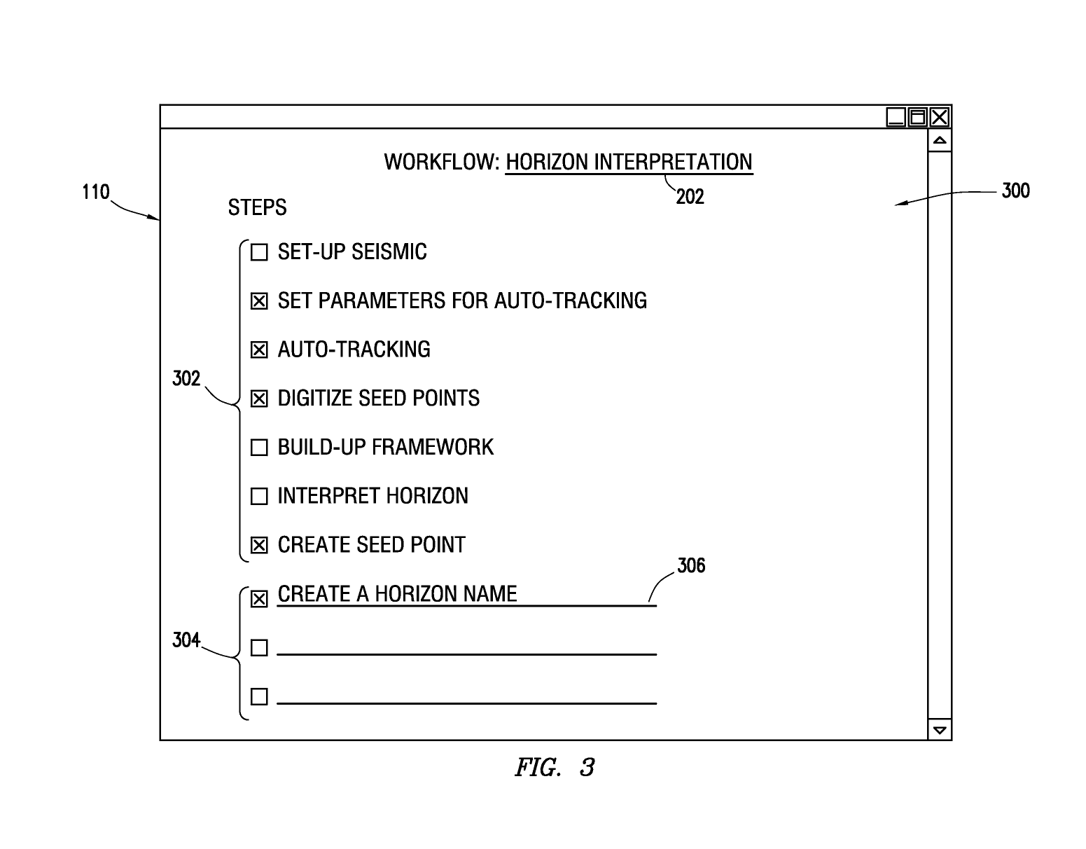

From the list of predetermined steps 204, each user will select which of the predetermined steps he or she deems to be of significance with respect to the workflow at hand (e.g., Horizon Interpretation). In many cases, the steps selected by the users are steps for which each user desires additional or specific mentoring. Each user in the group will spend a short amount of time (e.g. 5-10 minutes) selecting steps and/or providing his or her own. The selection of predetermined steps on a computer system by a first user is shown in FIG. 3.

FIG. 3 shows an example screenshot 300 of what user 102 might see on the display device of computer system 110 in accordance with at least some embodiments. The screenshot 300 may show the name 202 of the workflow (e.g., Horizon Interpretation), as well as the list of the pre-determined steps as determined, in part, by the mentor 100 in the previous phase. In the example shown in FIG. 3, the predetermined steps 302 are a combination of steps 204 and 206 from FIG. 2. Each of the predetermined steps is configured to be selectable.

In one embodiment, each of the predetermined steps 302 may have a selectable checkbox. In another embodiment, the user 102 may “drag-and-drop” each desired step into a designated location on the screen using an input device such as a mouse or a stylus (not specifically shown). In addition to selecting from the list of predetermined step, section 304 is provided in which the user 102 may provide his or her own additional step(s) which may not have been provided in the list of predetermined steps. Providing a user-defined step may be by way of typing it in to section 304; dragging-and-dropping, handing the mentor a handwritten note (discussed in more detail below).

In the example of FIG. 3, user 102 has selected the following steps from the list of predetermined steps 302: “set parameters for auto-tracking”; “auto-tracking”; “digitize seed points”; and “create seed point”. In addition, user 102 has added into section 304 the user-provided step: “create a horizon name.”

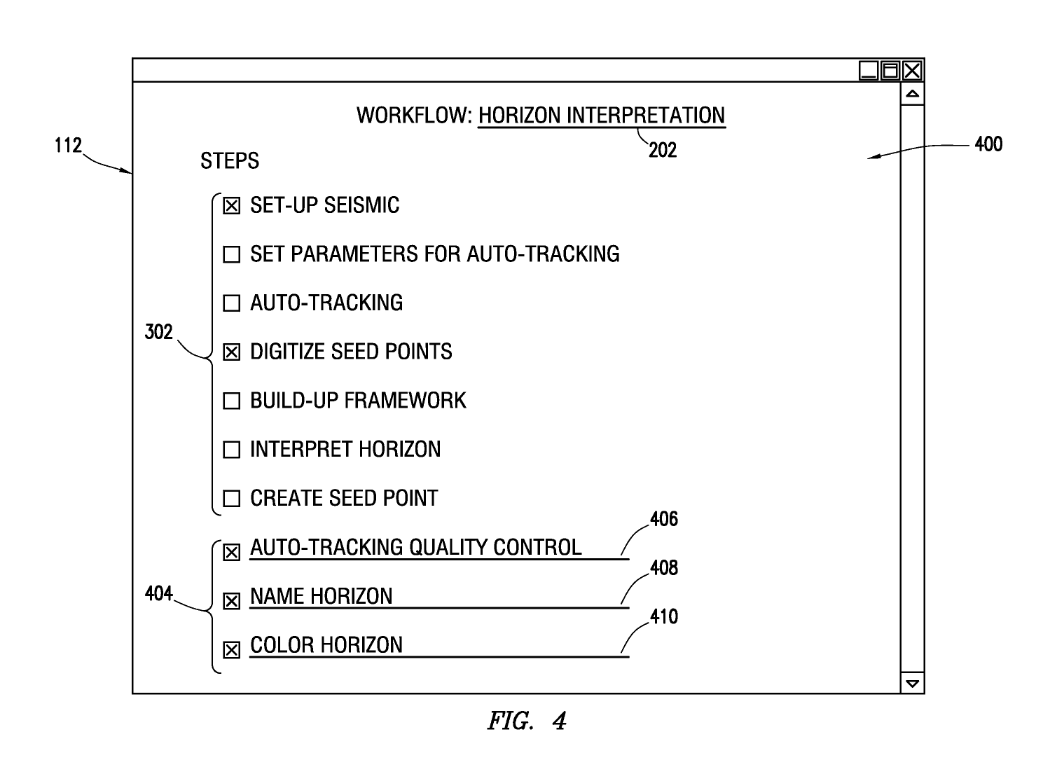

FIG. 4 shows an example screenshot 400 of what user 104 might see on the display device of computer system 112 in accordance with at least some embodiments. In this example, and using the same available methods and systems described in reference to FIG. 3 (i.e., with regard to user 102), user 104 selects a plurality of steps from the list of predetermined steps 302. In FIG. 4, user 104 has selected two of the predetermined steps 302: “set-up-seismic” and “digitize seed points.” In addition, user 104 has also provided three additional steps in section 404: step 406 “auto-tracking quality control”; step 408 “name horizon”; and step 410: “color horizon.”

Recalling FIG. 3, step 306 “create a horizon name” was a unique step not included in the list of predetermined steps 302. In FIG. 4, however, user 104 has provided unique steps 408 and 410, “name horizon” and “color horizon,” respectfully. In addition, user 104 has provided a third step 406: “autotracking quality control.” In this embodiment, step 406 appears to be similar to the predetermined step: “autotracking.”

User 104 may have entered the “autotracking quality control” step because he or she did not notice the step in the list of predetermined steps. However, in another embodiment, the user 104-provided step may appear similar in language, but is not similar in user 104's mind. Thus, in a later phase, an algorithm may be used to aggregate similar steps (discussed in more detail below).

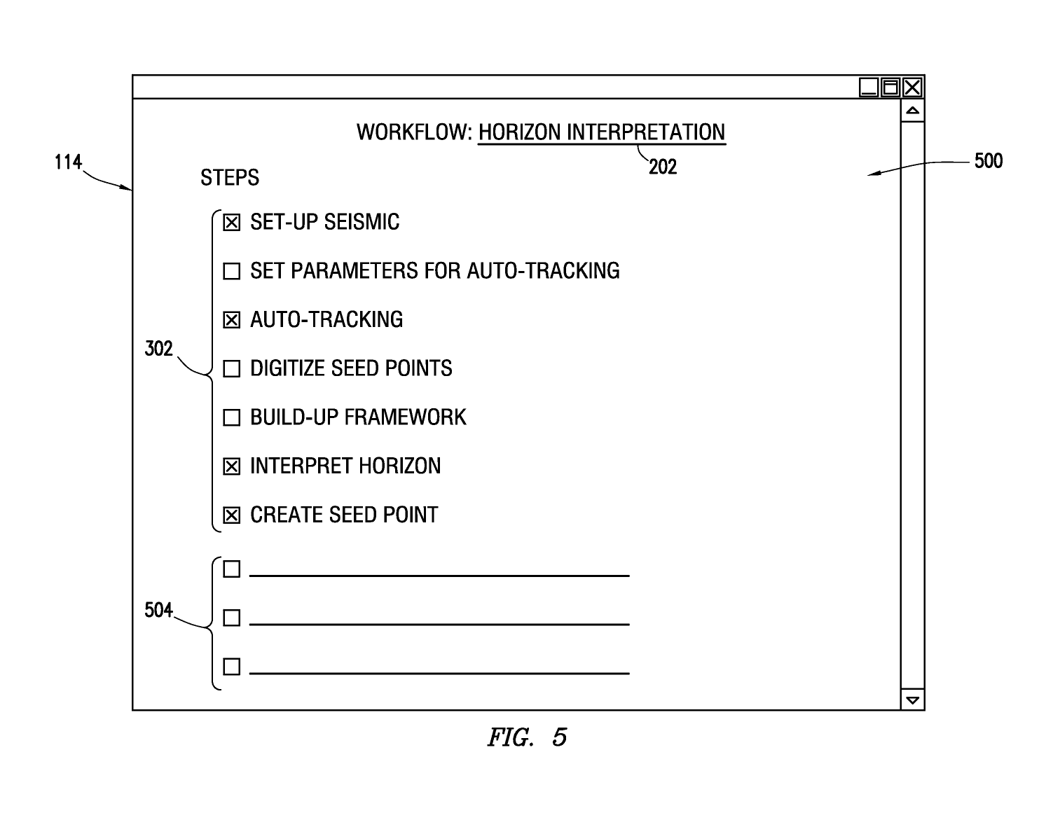

FIG. 5 shows an example screenshot 500 of what user 106 might see on the display device of computer system 114 in accordance with at least some embodiments. In this example, and using the same available methods and systems described in reference to FIGS. 3 and 4, user 106 has selected the following steps from the list of predetermined steps 502: “set-up-seismic”; “auto-tracking”; “interpret horizon”; and “create seed point”. In this example, user 106 has not provided any additional steps in section 504.

Before continuing to a discussion of Phase 3, another embodiment of determining steps is discussed. In this embodiment, a combination of software and paper technology is used.

Phase 2—Users Respond with Preferred Steps (Paper Method)

In the paper method embodiment, software running on the computer systems may be combined with a paper-and-pencil exercise. For example, in another embodiment, each user 102, 104, and 106 in the workshop is given a pad of notepaper and a pen or pencil. In one embodiment, each user may be given a pad of small adhesive note paper (e.g., POST-IT® brand notes) upon which each user will write an individual step (one step per adhesive note) he or she would like to be mentored on during the session. In another embodiment, other types of paper may be considered such as notebook paper or scrap paper. The users may affix their notes to a large work space visually accessible to the entire group, such as to display system 122. In another embodiment, the users may individually write steps on a whiteboard or chalkboard, or they may verbally provide steps, which are then written on display system 122. In yet another embodiment, the notes may be simply handed to the mentor. Regardless of the method of which the mentor sees or receives the steps, the mentor will input the steps into section 206 of the program executing on the mentor's computer system (from FIG. 1).

Phase 3—Grouping Steps

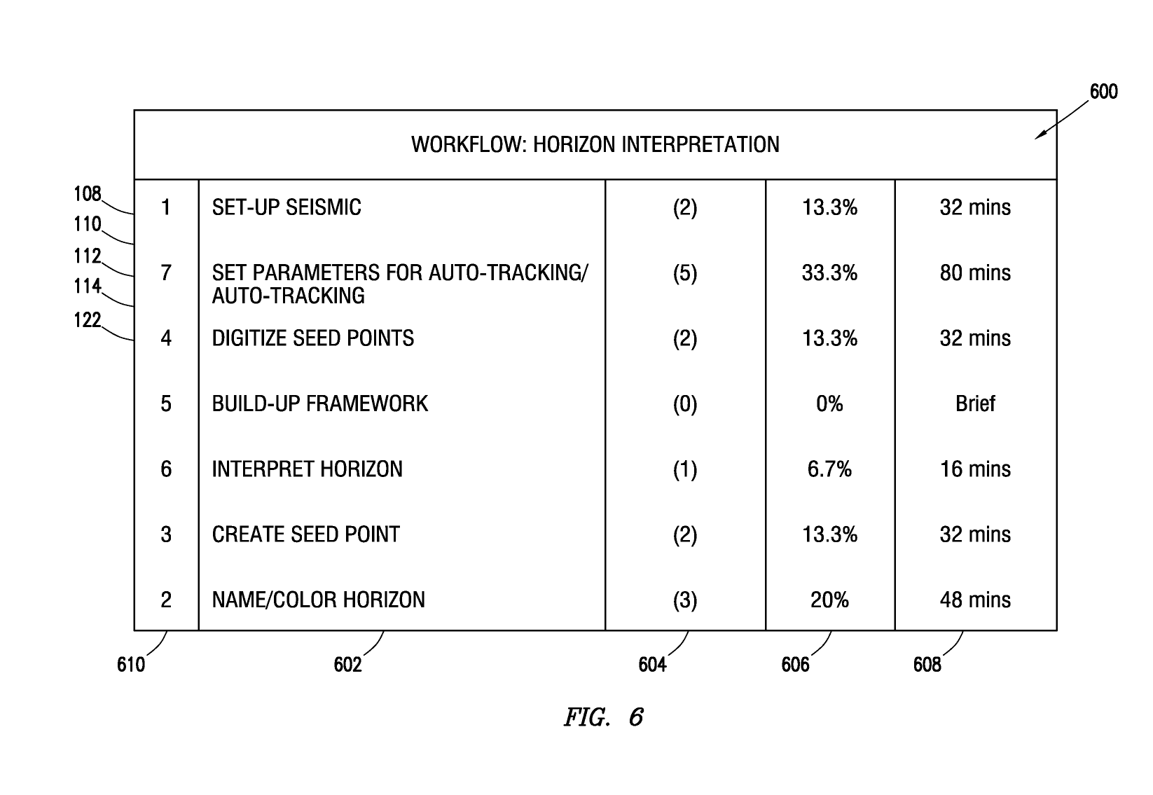

FIG. 6 shows an example screenshot 600 in accordance with at least some embodiments. In one embodiment, screenshot 600 may be displayed only on the display device of computer system 108 (i.e., the mentor's computer system). In another embodiment, screenshot 600 may be displayed on the display devices of each of the computer systems in the room (i.e., computer systems 110, 112 and 114). In addition, screenshot 600 may be shown on the display system 122 which can be seen by the entire group.

In one embodiment, software executing on a computer system (e.g., the mentor's computer system, a user's computer system, a remote computer system) determine a “relevance” weight value to each of the steps. The relevance weight value determines how much of the time remaining in the session will be allocated to each of the steps. Before a weighting can be determined, however, similar steps may be grouped together to avoid duplication.

In some cases, all of the steps selected by the users were selected from the list of predetermined steps 302. In other cases, the mentor and users provided additional steps. Thus, the software may make a determination as to whether any of the steps provided by the users are the same as the steps provided in the list of predetermined steps. In this scenario, the program may use a keyword-matching algorithm to determine the similarity between the steps. For example, referring again to FIG. 2, user 102 provided step 208: “create seed point.” The user-provided step “create seed point” is similar to one of the predetermined steps: “digitize seed point.” In this case, the program may determine that “create seed point” and “digitize seed point,” while similar, are not the same step, and thus considers them two separate steps. In contrast however, a user-provided step may be determined to be the same as a predetermined step.

Returning again to FIG. 4, user 106 provided step 406: “auto tracking quality control.” The user-provided step “auto tracking quality control” is similar to the predetermined step “auto-tracking.” In this case, the program may determine that “auto tracking quality control” and “auto-tracking” are, in fact, the same step. Thus, when determining the weight of each step in the session, “auto tracking quality control” may be considered to be the “auto-tracking” step from the list of predetermined steps as well as the predetermined step “set parameters for autotracking.”

In one embodiment, the program may utilize a keyword-similarity determining algorithm to determine whether each of the selected and/or predetermined steps is the same as other selected and/or provided steps. In other embodiment, the program may utilize a more complex algorithm which takes into account the actual words used as well as other considerations. In this embodiment, a type of artificial intelligence may be implemented which takes into account data from previous sessions.

In addition to grouping similar or same steps using an algorithm, similarity might be determined by a discussion with the group. More specifically, the mentor may ask the users of the group what they intended with each selected and/or user-provided step, and the grouping may thus be determined by a verbal and interactive discussion.

After the steps have been grouped, if necessary, a relevance weight value for each of the steps is determined. Due to the fact each example mentoring session is to be completed over a limited number of hours in a single day, the amount of time allocated to each of the steps of the workflow based on the respective weight values is allocated in such a way to provide efficient mentoring to the group for the steps the group has indicated are most needed.

Phase 4—Relevance Weighting

Referring still to FIG. 6, FIG. 6 shows an example allocation of time assigned to each step based on a determination of relevance weighting. The program determines a weight value based how relevant each step is to the current group. In one embodiment, the determination of the weight value may be made by way of a mathematical algorithm. Once the relevance weight value is determined, an allocation of mentoring time is assigned to each step.

In column 602, a list of the predetermined steps and any additional steps is shown. In some embodiments, and as previously discussed, additional steps may be combined into a single step based on the determined similarity of steps. In FIG. 6, for example, the two steps: “set parameters for autotracking” and “autotracking” have been combined into one step. Likewise, the two steps: “name horizon” and “color horizon” were determined to be similar enough to be combined into one step.

Column 604 shows the number of times each step was selected by the users. In this example, the step regarding “autotracking” was selected the most times, whereas the predetermined step “build up framework” was not selected by any users. In some cases, however, even if the users have not selected a step from the list of predetermined steps, some amount of time may be allocated to mentoring on non-selected predetermined step.

Column 606 shows the percentage of time each respective step will be given in the session. Although a percentage was calculated based on the number of each step selected compared to the overall number of selections made, in another embodiment, an algorithm may determine the relevancy weight and allotted number of minutes based on other considerations. For example, some selected steps may have been selected by many users, but the step itself would require little time on which to mentor. For other steps, only a handful of users may have selected the step, but mentoring the specific step may take more time.

Phase 5—Allocating Time in Mentoring Session

Column 608 shows the amount of time each respective step will be discussed or taught during the session. In addition, a discussion may be had in which the steps are placed in a logical order. For example, the mentor and the users may determine that each step should occur, or should be mentored, in a specific order.

For example, using the methods above, each step is organized into a workflow order (column 610) and an amount of time is allocated for the mentoring of each step (column 608). In this example, imagine the remaining time allotted for training during session is 4 hours. Thus, the steps may be organized and time allocated as follows:

Step 1: Set up seismic/display seismic (32 minutes);

Step 2: Create a horizon name; give the horizon a color (48 minutes);

Step 3: Create seed points (32 minutes);

Step 4: Start digitizing seed points (32 minutes);

Step 5: Build up the framework (brief overview);

Step 6: Interpret the horizon on a cube (16 minutes); and

Step 7: Set up parameters for auto-tracking/auto-tracking (80 minutes);

At this point, the mentor may ask the group of they have any questions regarding the created workflow, including if any steps are missing or have erroneously been included. In some cases, some of the steps are best saved for a workshop on a different topic, and are thus not included in this instant workshop. Additionally, the users may agree to spend less time or more time on some steps. For example, although the combined “name/color horizon” step yielded a frequency of 20%, it may be unlikely that 48 minutes of the session needs to be allocated to mentoring on the “name/color horizon” step. Thus, times may be adjusted to reflect the group's needs. At the end of this discussion, a complete and customized workflow mentoring plan for the particular session has been created.

Phase 6—Mentoring on the Determined Plan

Once the group agrees the customized workflow mentoring plan represents the wishes of the group, the mentor leads the group through a demonstration of the group-created workflow mentoring plan. The demonstration may last 10 to 20 minutes. In one embodiment, the demonstration may be “follow along,” in which each user interacts with the software on each user's computer system during the workshop in a variety of different ways, such as by taking screen-captures, taking notes, and other contemplated ways of interaction with the software. In another embodiment, demonstration may be mentor-led where the users do not interact with the software, and instead watch the mentor proceed through the steps.

Once the demonstration is over, the mentor will lead the group through the customized workflow mentoring plan created by the group. For reference, a predetermined workflow file may be given to the group in the form of flow diagram handout created by a flow diagraming software (e.g. MICROSOFT Visio). In one embodiment, while interacting with the software during the teaching phase, the users may use example data provided by the mentor. In another embodiment, each user may use the user's own data in working through the workflow during the session. In yet another embodiment, a combination of data may be used.

Phase 7—Evaluation

Before the workflow mentoring session concludes and the group leaves, the mentor will provide the group with an evaluation form in order to ascertain whether the current workshop covered the specific needs of the users in the group. The evaluation form may be submitted and received by any of the methods previously discussed; for example, the evaluation may be sent to each computer system in a digital form, or the evaluation may be paper based.

Information gathered from the evaluation form may be used to refine each workflow mentoring session for each topic. For example, based on the evaluations, the steps included in the predetermined steps provided to the users may change. In another example embodiment, the algorithm which allocates a percentage of time for each step may be refined in order to meet the mentoring needs of the users.

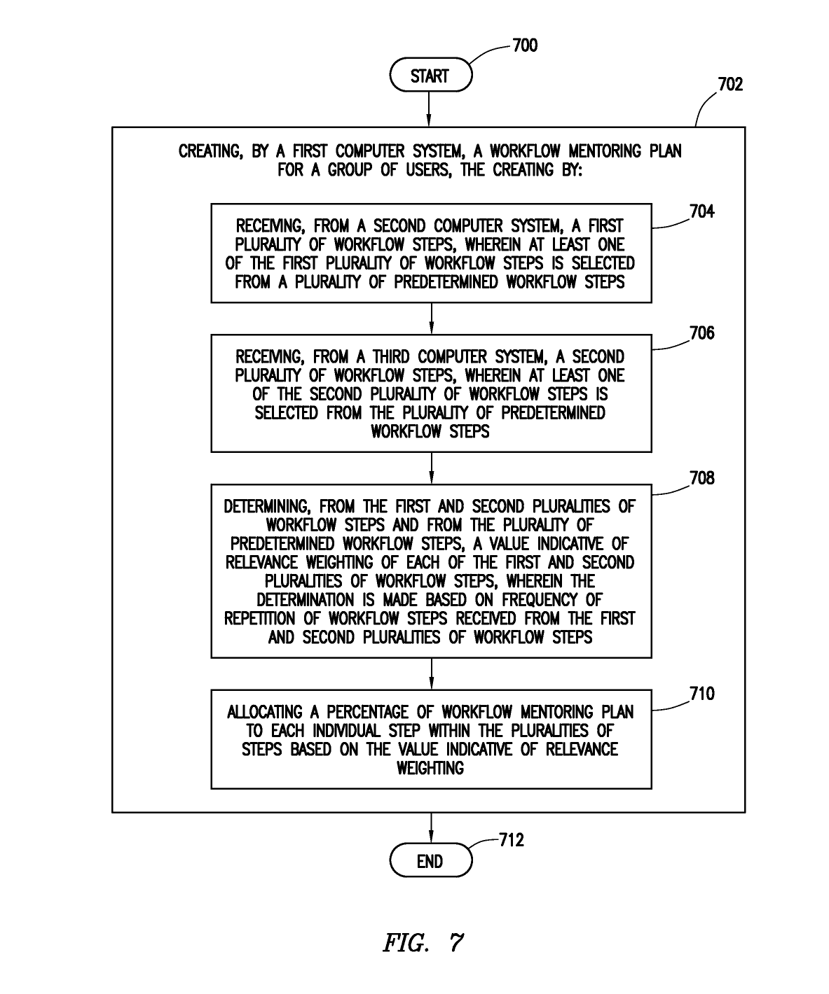

FIG. 7 shows a workflow mentoring session method in accordance with at least some embodiments. In particular, the method starts (block 700) by: creating, by a first computer system, a workflow mentoring plan for a group of users (block 702), the creating by: receiving, from a second computer system, a first plurality of workflow steps, wherein at least one of the first plurality of workflow steps is selected from a plurality of predetermined workflow steps (block 704); receiving, from a third computer system, a second plurality of workflow steps, wherein at least one of the second plurality of workflow steps is selected from the plurality of predetermined workflow steps (block 706); determining, from the first and second pluralities of workflow steps and from the plurality of predetermined workflow steps, a value indicative of relevance weighting of each of the first and second pluralities of workflow steps, wherein the determination is made based on frequency of repetition of workflow steps received from the first and second pluralities of workflow steps (block 708); and allocating a percentage of the workflow mentoring plan to each individual step within the pluralities of steps based on the value indicative of relevance weighting (block 710). Thereafter, the method ends (block 712).

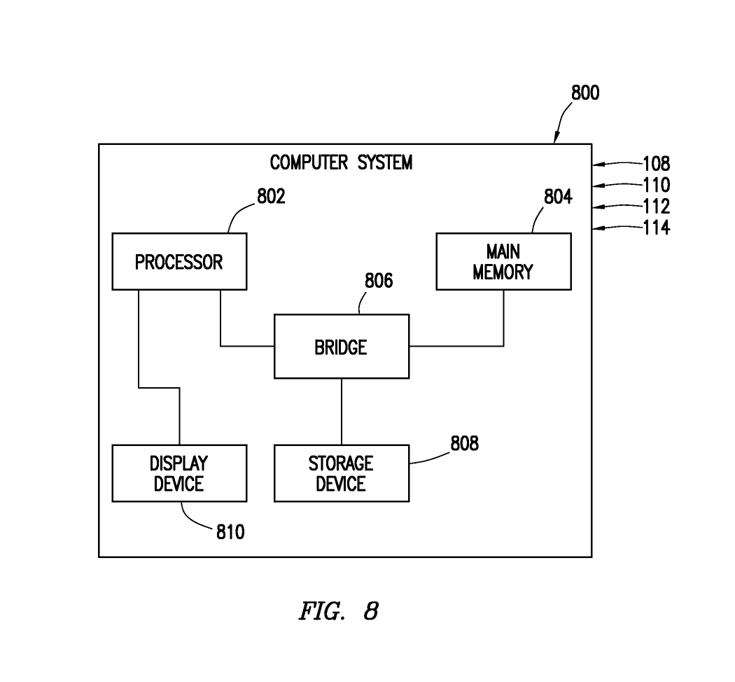

The various embodiments may be implemented as a software program operating on one or more computer systems. Thus, the method may be a computer-implemented method that takes as input the workflow steps determined in each mentoring session. FIG. 8 shows a computer system 800, which may be illustrative of a computer system upon which the various embodiments may be practiced. The computer system 800 may be illustrative of, for example, computer systems 108, 110, 112, and 114. In particular, computer system 800 comprises a processor 802 and the processor couples to a main memory 804 by way of a bridge device 806 Moreover, the processor 802 may couple to a long term storage device 808 (e.g., a hard drive, solid state disk, memory stick, optical disc) by way of the bridge device 806 Programs executable by the processor 802 may be stored on the storage device 808 and accessed when needed by the processor 802 The program stored on the storage device 802 may comprise programs to implement the various embodiments of the present specification, such as sending and receiving workflow step, as well as allocating a percentage of training time to selected workflow steps. In some cases, the programs are copied from the storage device 808 to the main memory 804 and the programs are executed from the main memory 804. Thus, the main memory 804 and storage device 808 shall be considered computer-readable storage mediums.

It is noted that while theoretically possible to perform some or all the calculations discussed above by a human using only pencil and paper, the time measurements for human-based performance of such tasks may range from man-hours to man-years, if not more. Thus, this paragraph shall serve as support for any claim limitation now existing, or later added, setting forth that the period of time to perform any task described herein less than the time required to perform the task by hand, less than half the time to perform the task by hand, and less than one quarter of the time to perform the task by hand, where “by hand” shall refer to performing the work using exclusively pencil and paper.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments and/or to create a non-transitory computer-readable medium (i.e., not a carrier wave) that stores a software program to implement the method aspects of the various embodiments.

References to “one embodiment,” “an embodiment,” “some embodiment,” “various embodiments,” or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. For example, while the various embodiments have been described in terms of creating a workflow mentoring plan for a group of users, this context shall not be read as a limitation as to the scope of one or more of the embodiments described—the same techniques may be used for other embodiments. It is intended that the following claims be interpreted to embrace all such variations and modifications.

What is claimed is:

1. A method comprising:
creating, by a first computer system, a workflow mentoring plan for a group of users, the creating by:
receiving, from a second computer system, a first plurality of workflow steps, wherein at least one of the first plurality of workflow steps is selected from a plurality of predetermined workflow steps;
receiving, from a third computer system, a second plurality of workflow steps, wherein at least one of the second plurality of workflow steps is selected from the plurality of predetermined workflow steps;
determining, from the first and second pluralities of workflow steps and from the plurality of predetermined workflow steps, a value indicative of relevance weighting of each of the first and second pluralities of workflow steps, wherein the determination is made based on frequency of repetition of workflow steps received from the first and second pluralities of workflow steps; and
allocating a percentage of the workflow mentoring plan to each individual step within the pluralities of steps based on the value indicative of relevance weighting.

2. The method of claim 1 further comprising:
receiving, from a fourth computer system, a third plurality of workflow steps; and
wherein determining further comprises determining from the first, second, and third pluralities of workflow steps.

3. The method of claim 1 further comprising, after creating the workflow mentoring plan, training the group of users based on the allocated percentages.

4. The method of claim 3 wherein training further comprises training by way of applying custom workflow data provided by each user to the workflow mentoring plan.

5. The method of claim 1 wherein the first computer system sends the plurality of predetermined workflow steps to the second computer system and to the third computer system.

6. The method of claim 1 wherein allocating further comprises allocating by way of an algorithm.

7. The method of claim 1 wherein determining the value indicative of relevance weighting further comprises determining by way of user input.

8. The method of claim 1 wherein creating the workflow mentoring plan for a group of users further comprises creating for at least three users.

9. A method comprising:
creating, by a first computer system, a workflow mentoring plan for a group of users, the creating by:
receiving, by a first user, a first plurality of hand-written workflow steps from a second user, each hand-written workflow step provided to the first user on a piece of paper, wherein at least one of the first plurality is selected from a plurality of predetermined workflow steps, and wherein the first user inputs the first plurality of hand-written workflow steps onto a computer program executing on the first computer system;
receiving, by the first computer system, a second plurality of workflow steps from a second computer system, wherein at least one of the second plurality is selected from the plurality of predetermined workflow steps;
determining, from the first and second pluralities of workflow steps and from the plurality of predetermined workflow steps, a value indicative of relevance weighting of each of the workflow steps, wherein the determination is made based on the frequency of repetition of workflow steps received from the pluralities of workflow steps; and
allocating a percentage of the workflow mentoring plan to each individual step within the pluralities of steps based on the value indicative of relevance weighting.

10. The method of claim 9 further comprising, after creating the workflow mentoring plan training the group of users on each individual step for the allocated percentage of the workflow mentoring plan.

11. The method of claim 10 wherein the training further comprises training by way of applying custom workflow data provided by each user to the workflow mentoring plan.

12. The method of claim 9 wherein allocating further comprises allocating by way of an algorithm.

13. The method of claim 9 wherein determining the values indicative of relevance weighting further comprises determining by way of user input.

14. The method of claim 9 wherein creating the workflow mentoring plan for a group of users further comprises creating for at least three users.

15. A computer system comprising:
a processor;
a memory coupled to the processor;
the memory storing a program that, when executed by the processor, causes the processor to:
create a workflow mentoring plan for a group of users, the creating by causing the processor to:
receive a plurality of workflow steps from the group of users;
determine, from the plurality of workflow steps and a plurality of predetermined workflow steps, a value indicative of relevance weighting of each of the workflow steps, wherein the determination is made based on the frequency of repetition of workflow steps received from the pluralities of workflow steps; and
allocate a percentage of the workflow mentoring plan to each individual step within the plurality of steps based on the value indicative of relevance weighting.

16. The computer system of claim 15 wherein the computer system is at least one selected from the group consisting of: a desktop computer; a laptop computer; a smartphone; and a tablet computing device.

17. The computer system of claim 15 further comprising, before receiving the plurality of workflow steps from the group of users, sending to a second computer system a plurality of predetermined workflow steps.

18. The computer system of claim 15 wherein when the processor allocates, the program further causes the processor to allocate by way of an algorithm.

19. A first computer system comprising:
a processor;
a memory coupled to the processor;
the memory storing a program that, when executed by the processor, causes the processor to:
receive, from a second computer system, a predetermined set of workflow steps;
send, to the first computer system, a first plurality of workflow steps, wherein at least one of the first plurality of workflow steps is selected from the predetermined workflow steps; and then
receive an indication of a workflow, the workflow created by the first computer system; and
apply user data to the workflow, wherein the user data is input by a first user interacting with the first computer system by way of an input device.

20. The first computer system of claim 19 further comprising an input device coupled to the processor.

21. The system of claim 19 wherein the first computer system is at least one selected from the group consisting of: a desktop computer; a smartphone, a tablet computer; and a laptop computer.

22. A non-transitory computer-readable medium storing a program that, when executed by a processor, causes the processor to:
create a workflow mentoring plan for a group of users, the creating by causing the processor to:
receive a plurality of workflow steps from the group of users;
determine, from the plurality of workflow steps and a plurality of predetermined workflow steps, a value indicative of relevance weighting of each of the workflow steps, wherein the determination is made based on the frequency of repetition of workflow steps received from the pluralities of workflow steps; and
allocate a percentage of the workflow mentoring plan to each individual step within the plurality of steps based on the value indicative of relevance weighting.

23. The non-transitory computer-readable of claim 22 further comprising, before receiving the plurality of workflow steps from the group of users, sending to a second computer system a plurality of predetermined workflow steps.

24. The non-transitory computer-readable of claim 22 wherein when the processor allocates, the program further causes the processor to allocate by way of an algorithm.
